(19) United States
(12) Patent Application Publication
(10) Pub. No.: US 2006/0111974 A1
(43) Pub. Date: May 25, 2006

(54) Method and system for rewarding use of a communications network site

(76) Inventor: Ashraf Nashed, Whitehouse Station, NJ (US)

Correspondence Address: NORRIS MCLAUGHLIN & MARCUS, P.A., P O BOX 1018, SOMERVILLE, NJ, 08876, US

(21) Appl. No.: 11/131,809

(22) Filed: May 18, 2005

Related U.S. Application Data
(60) Provisional application No. 60/630,962, filed on Nov. 24, 2004.
(60) Provisional application No. 60/651,195, filed on Feb. 9, 2005.

(51) Int. Cl. G06Q 30/00

(52) U.S. Cl. 705/14

(57) ABSTRACT

Users of a communications network, when registered with a base communications network site on the network, automatically are awarded credits when they interact with the base site. The registered users can redeem the credits at any communications network site that is partnered with the base site in exchange for obtaining access to information and content, or credit towards the purchase of products and services, available on the partner sites.

### RELATED APPLICATIONS

This application claims the benefit of U.S. Provisional Application Ser. No. 60/630,962, filed Nov. 24, 2004 and U.S. Provisional Application Ser. No. 60/651,195, filed Feb. 9, 2005, in the name of the inventor named in this application and incorporated by reference herein.

### FIELD OF THE INVENTION

The present invention relates generally to use of resources available on a communications network and, more particularly, to awarding credits to users of a communications network based on their use of a base communications network site where the users can redeem the credits for obtaining access to premium pages of the communications network sites that are partnered with the base website and for retrieving data, such as audio or video content, or purchasing products or services available on the partner sites.

### BACKGROUND OF THE INVENTION

Communications networks include communication network sites that facilitate a user's efforts to access and obtain information from other communications network sites that are coupled to or exist on the networks. The communications network currently used by most individuals is the Internet. The Internet includes many websites that seek to disseminate information, content, products or services. The websites often includes a search engine that assists users to locate desired information, products, services, content, etc.

The owners of websites obtain revenue, in part, from advertisers that advertise on the websites. The advertisers pay the websites to display their advertisement based on the number of hits the websites receive. The websites, therefore, desire to attract individuals to access their respective websites and, for example, use an application such as a search engine, advertisement bar or other content included on their websites, rather than to visit another website that may contain the same or a competing application.

There exists a need for creating an incentive for a user to access a particular a communications network site, rather than other communications network sites, on the communications network so that the site can increase the revenues it receives from advertisers.

### SUMMARY OF THE INVENTION

In accordance with the present invention, a base communications network site, such as a website on the Internet including applications such as a search engine, browser toolbar or advertisement bar, partners with other communications network sites, such as a content provider website, and automatically awards credits to a user registered with the base site when the registered user interacts with the base site. The registered user can redeem the credits awarded at the partner sites to, for example, obtain access to premium or subscription-only web pages available at the partner websites. The automatic award of redeemable credits to registered users who interact with the base website, thus, creates an incentive for users of the communications network to use the base website rather than another website to, for example, search the Internet for information, content, products and services. In a preferred embodiment, the base website automatically awards credits to a user that registers with the base website each time that the registered user interacts with the base website, such as by accessing or using an application found on the base website. By registering with the base website, the user can obtain access to and, for example, retrieve content available only on the premium web pages of a partner website without becoming a paid subscriber of the partner website.

In an alternative embodiment, the user can redeem credits to purchase products or services offered at a partner website, or to retrieve data, such as audio, video or text content, available at the partner website.

### BRIEF DESCRIPTION OF THE DRAWINGS

Other objects and advantages of the present invention will be apparent from the following detailed description of the presently preferred embodiments, which description should be considered in conjunction with the accompanying drawings in which like references indicate similar elements and in which:

FIG. 1 is a block diagram of a communications network system for rewarding use of a communications network site in accordance with the present invention.

FIG. 2 is a high level flow diagram of a process for rewarding registered users of a base website with credits that can be redeemed at a partner website in accordance with the present invention.

FIG. 3 is a high level flow diagram of a process for determining if a registered user has sufficient credits to access premium web pages of a partner website in accordance with the present invention.

FIG. 4 is a high level flow diagram of a process for registering a user at a base website and awarding the registered user with credits in accordance with the present invention.

### DETAILED DESCRIPTION OF THE INVENTION

The method and system of the present invention create incentives for a user of a communications network to interact with a specific, base communications network site. Following registration of the user with the base site, the user is awarded credits based on interaction with the base site, such as accessing or performing applications on the base site, and the user can redeem the credits at one or more partner communications network sites that have entered into commercial arrangements with the base site. The credits can be redeemed, for example, to obtain access to premium pages of the partner sites, for monetary credits that c an be used in connection with the purchase of products or services available on the partner sites and for the ability to download premium or subscription-only content available on the partner websites.

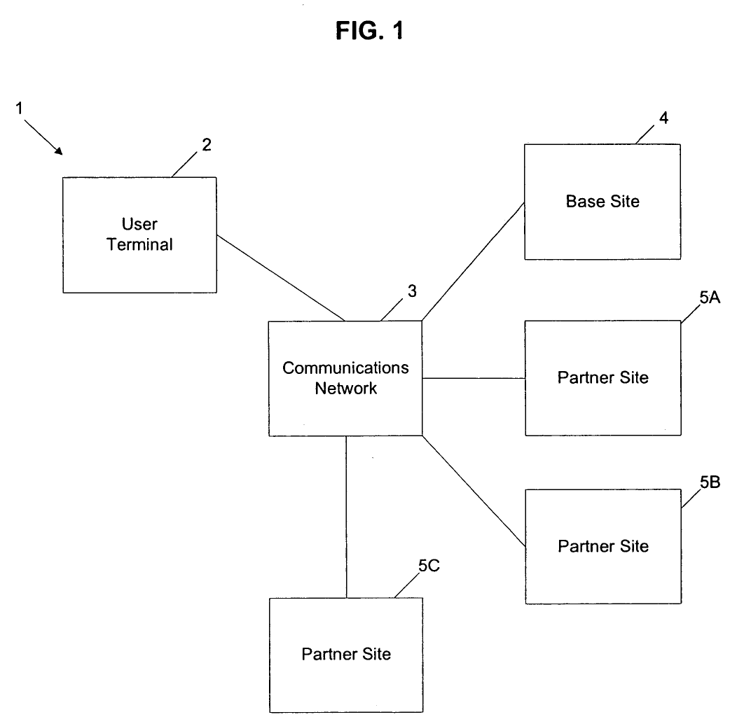

FIG. 1 shows in block diagram form a preferred embodiment of a communications network system 1 for rewarding use of a communications network site in accordance with the present invention. Referring to FIG. 1, the system 1 includes a user terminal 2 coupled to a communications network 3. In addition, each of a base communications network site 4 and a plurality of partner communications network sites 5 are coupled to the communications network 3.

It is to be understood that each of the communications network sites in the system 1 which is described below as performing data processing operations is a software module or, alternatively, a hardware module or a combined hardware/software module. In addition, each of the data processing modules in the system 1 suitably contains a memory storage area, such as RAM, for storage of data and instructions for performing processing operations in accordance with the present invention. Alternatively, instructions for performing processing operations can be stored in hardware in one or more of the databases in the system 1.

User terminal 2 is a conventional computer or handheld device, such as a stand alone personal or laptop computer including a monitor, mouse and keyboard, having communications capability and that a user can operate to establish a communications link with a remote communications device over a communications network, such as the Internet. The network 3 is any conventional communications network, such as the Internet or any wired or wireless electronic network or an optical fiber network, that serves as a medium for establishing a communications link between two communication devices.

The communications network sites 4 and 5 are preferably websites having communications capabilities, and include servers and associated processors that perform data processing operations and provide for the exchange of information over the network 3, such as communicating information with web browsers operating on a user terminal over the communication network 3, as well known in the art. The sites 4 and 5 can include such applications as a search engine, content links and advertisement bars, and also have transaction capabilities that permit a user accessing the site via the browser on the user terminal to purchase products and services and also to download content, as well known and conventional in the art.

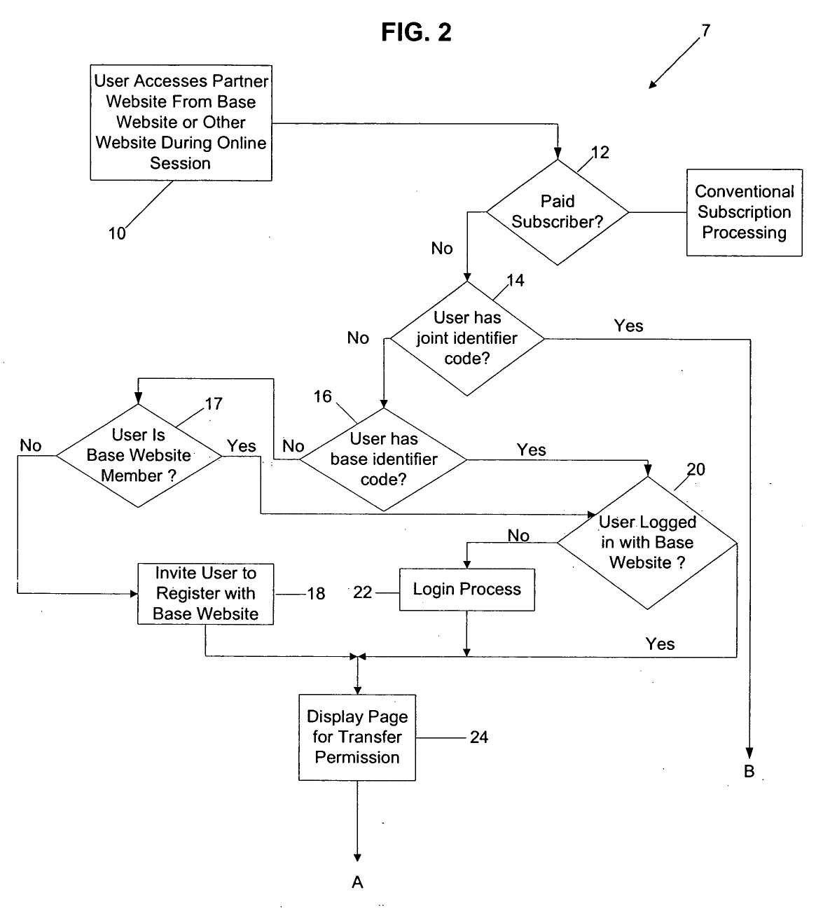

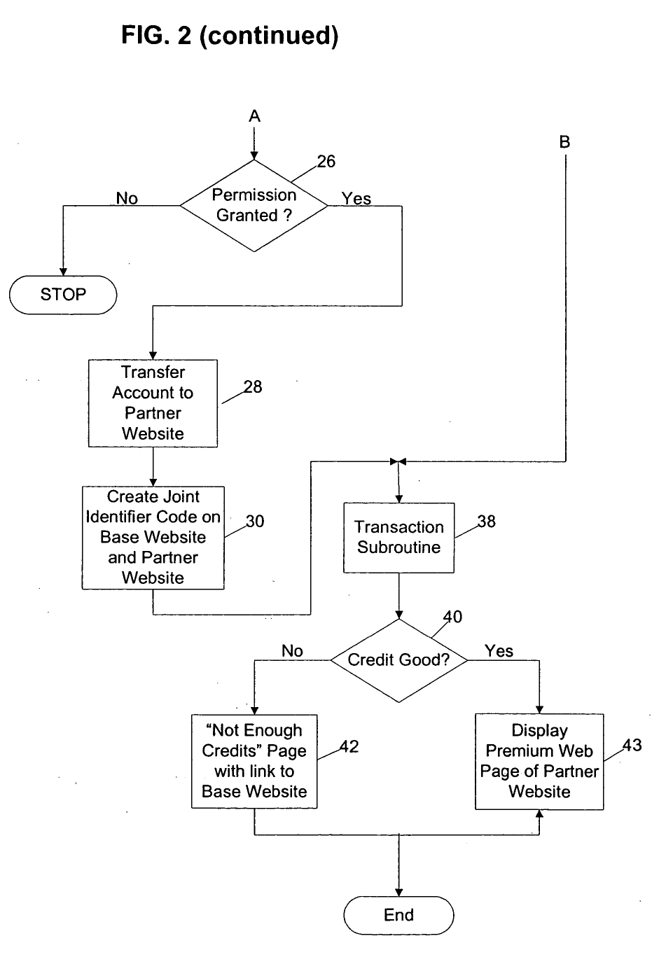

FIG. 2 shows a preferred process 7 for awarding registered users of a base website with credits that can be redeemed to obtain access to premium content or to retrieve data or purchase products or services available at a partner website in accordance with the present invention. For purposes of illustration, the process 7 is described in connection with operations performed on the system 1 as shown in FIG. 1 where the communications network sites are websites and the network 3 is the Internet. Referring to FIG. 2, in step 10 an Internet user, during an online session at the user terminal 2, accesses a desired commercial premium content website 5A, such as the website of the NEW YORK TIMES, that is a website partner of the base website 4 and includes premium web pages available for access only by paid subscribers. The premium web pages include, for example, specialized premium content and, optionally products or services that can be purchased or data that can be retrieved only by a paid subscriber. The user can access the partner website 5A from the base website 4 with which the partner website is associated, or any other website. In an alternative preferred embodiment, the base website and the partner website have a common ownership interest.

In step 12, the partner website 5A determines if the user is a paid subscriber of the partner website. If yes, the user, as a paid subscriber, is permitted to access the premium web pages of the partner website in accordance with a conventional subscription service, which is not a part of the present invention.

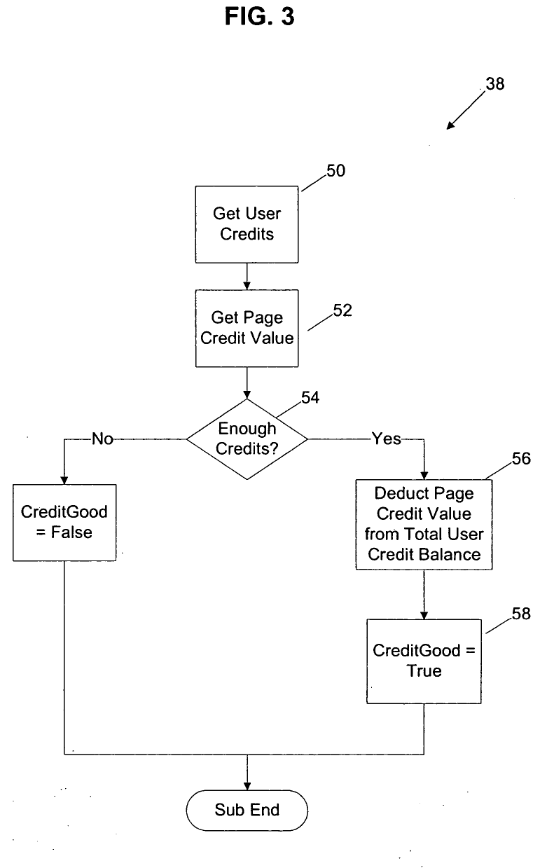

If the determination is no in step 12, then in step 14 the partner website 5A determines if the user has been assigned a joint identifier code. The joint identifier code is, for example, one or more cookies placed on the terminal 2 that the user is using to connect to Internet websites, and identifies the user as registered with the base website 4 and also registered with the partner website 5A. If the determination is yes, a transaction subroutine process, as shown in FIG. 3 and which determines if the registered user has sufficient credits available to access the premium web pages of the partner website 5A or to purchase products and services or to retrieve data available at the partner website 5A, is performed in step 38.

If the determination is no in step 14, then in step 16 the partner website 5A determines if the user terminal 2 has a base identifier code, which can be in the form of a cookie or identification and password, indicating that the user is registered with the base website 4. If the determination is no in step 16, the partner website 5A requests the user in step 17 to respond whether he previously registered with the base website 4. For example, the user may be using a different user terminal than the one the user used to register with the base website 4, such that the terminal the user is using in the online session does not have a base identifier code thereon. Alternatively, the user may have registered with the base website 4 but the base identifier code previously placed on the user's terminal during registration may have been deleted. If the user responds no in step 17, the user is presented with a registration subroutine in step 18 that invites the user to register with the base website 4.

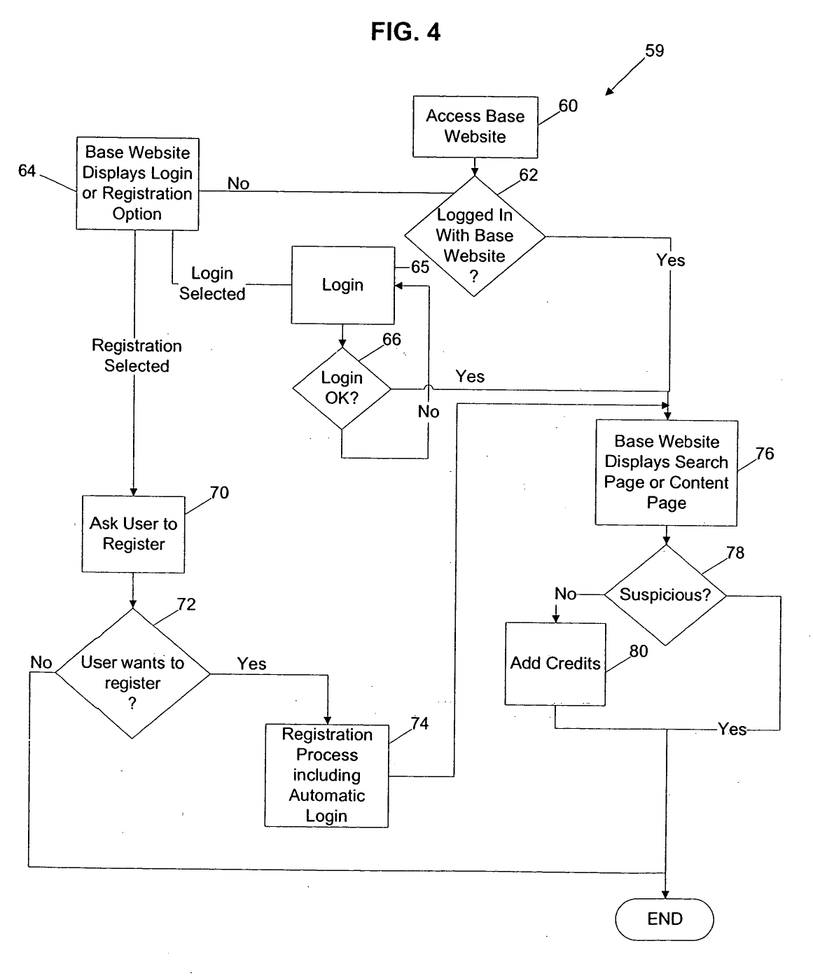

FIG. 4 shows a preferred process 59 for initially registering a user with the base website 4, which includes creating a base identifier code on the user terminal 2, and awarding a registered user with credits based on the user's interaction with the base website 4 in accordance with the present invention. By registering with the base website 4 and then subsequently accessing the base website 4 and also using applications available on the base website 4, such as performing searches using a search engine contained on the base website 4, the registered user acquires credits that can be redeemed to access premium content web pages of the partner websites 5, and to retrieve data and to purchase products or services made available on preferably premium, or alternatively non-premium, webpages of the partner websites 5. In a preferred embodiment, an initial number of free credits may be awarded on initial registration of the user with the base website 4.

Credits are automatically awarded to the registered user, preferably, each time that the registered user interacts with the base website 4, such as by accessing or using an application available on the base website 4. An advertiser maintaining an advertisement bar on the base website 4, for example, communicates with the base website 4 following the user's accessing the advertiser's website from the base website and the base website 4, in turn, automatically awards credits to the registered user.

Referring to FIG. 4, in step 60 the user terminal 2 links to the base website 4 after the user becomes communicatively connected to the Internet. Then in step 62 the base website 4 determines if the user previously logged in with the base website 4, such as during an earlier online session following connection to the Internet. If no, in step 64 the base website 4 displays a login page on the user terminal 2 that asks the user whether he is already registered with the base website 4 and would like to login, or whether he is not registered and would like to have additional information for potentially becoming registered with the base website 4.

If the user in step 64 indicates that he would like to login, in step 65 the base website 4 displays a login box at the user terminal 2 in which the user can enter login information, such as a password, and also displays options to the user at the terminal 2 to assist the user with login, such as sending the user an email with his password in the event the user forgot his login information. Then in step 66, the base website 4 determines if the password entered by the user is valid. If the password is not valid because, for example, the user entered the incorrect password, the base website 4 informs the user that login was not achieved and the base website 4 returns to step 65 so that the user can take steps to obtain the correct login and complete the login process.

If the user in step 64 indicates that he would like to register with the base website 4, in step 70 the base website 4 displays on the user terminal 2 a request that the user respond whether the user desires to register with the base website 4. The display provides information as to the advantages and rewards the user can obtain by registering with and using the base website 4 to, for example, perform searches. For example, the information may state that the user accumulates credits upon initial registration with the base website 4 and each time that the user accesses the base website 4 or uses an application on the base website 4, such as performing a search on a search engine or clicking on an advertisement bar on the base website 4, and that the registered user can redeem the credits in exchange for access to premium content on the partner websites 5, or for credits that can be applied to the purchase of products and services or to the retrieval of data available on the partner websites 5.

In step 72, the base website 4 determines if the user's response is affirmative concerning registration. If yes, in step 74 the base website 4 performs a registration process that collects relevant information from the user, such as contact information, demographic information and credit card information, creates a base identifier code on the user terminal 2 identifying the user as registered with the base website 4 and automatically logs the user in with the base website 4. In a preferred embodiment, step 18 of the process 7 includes steps 70, 72 and 74 of the process 59.

Following step 74, or if the determination in steps 62 or 66 is yes, in step 76 the base website 4 displays a search or content page on the user terminal 2. In step 78, the base website 4 determines if the request that a search be performed or content be retrieved is suspicious based on business rules that attempt to ensure that credits are not awarded based on attempts to illegitimately use the base website 4. For example, an illegitimate use is if the request at the base website 5 is received from a terminal of a registered user that repeatedly links to the base website 4, using an automated process, to accumulate credits without the registered user's controlling the actions of the terminal. If the search request is authenticated as being controlled by the registered user and not an automated process being performed on a registered user's terminal that contains a base identifier code, the base website 4 in step 80 adds credits to the user's account. The registered user, as explained below, can then redeem the credits to, for example, obtain access to premium content on a partner website 5.

In a preferred embodiment, the user automatically earns credits for each search request performed or page viewed on the base website. In another preferred embodiment, the registered user can purchase credits on the base website.

In a further preferred embodiment, the base website has entered into a credit conversion agreement with other businesses that provide a user with redeemable credits based on transactions performed with such businesses, and the conversion agreement provides that credits accrued with the other businesses can be converted into credits with the base website, and vice versa.

Referring again to the process 7 shown in FIG. 2, if the user responds yes in step 17, then in step 20 the partner website 5A determines if the user initially logged in with the base website 4 prior to reaching the partner website 5A. If the determination is no in step 20, the partner website 5A at step 22 provides that the user can login with the base website 4 either on the partner website 5A, or alternatively on the base website 4. In a preferred embodiment, the base website 4 or any partner website 5 can attend to login of a registered user and store account data, such as earned credits, for the registered user.

Once the user is logged in with the base website 4, in step 24 the partner website 5A displays a webpage on the user terminal 2 requesting the user's permission to transfer information from the user's account with the base website 4 to the partner website 5A. In step 26, the partner website 5A determines if permission was granted. If yes, in step 28 the base website 4 transfers information from the user's account at the base website 4 to the partner website 5A. Then in step 30 each of the partner website 5A and the base website 4 creates on its server a joint identifier code corresponding, or which can provide for access, to the user's account information and places the joint identifier code on the user terminal 2.

Following step 30, the partner website 5A performs transaction subroutine step 38, as shown in detail in FIG. 3, to determine whether the user can redeem credits earned based on use of the base website 4 to, for example, access premium web pages of the partner website 5A. Referring to FIG. 3, the subroutine step 38 includes step 50 where the partner website 5A retrieves from the base website 4 the current number of earned credits that the user has in his account (“user credit balance”). Then in step 52 the partner website 5A retrieves from its memory the page credit value corresponding to its premium website pages. In step 54, the partner website 5A determines if the user has sufficient credits to access the premium web pages, in other words, if the user credit balance exceeds the page credit value. If yes, in step 56 the partner website 5A deducts the page credit value from the user credit balance and provides that the user's account information at the base website 4 is suitably updated. In step 58, the partner website 5A sets a creditgood flag as true, which indicates that the user has sufficient earned credits available to access premium web pages on the partner website 5A.

If the determination in step 54 is no, the partner website 5A sets a creditgood flag as false, which indicates that the user has not earned sufficient credits required to access premium web pages on the partner website 5A.

In a preferred embodiment, different combinations of steps of the process 38 can be performed either on a partner website 5 or the base website 4.

In an alternative preferred embodiment, the partner website performs the transaction subroutine 38 to determine if the user has sufficient credits to retrieve content or to purchase products and services available on the partner website.

Referring again to FIG. 2, in step 40 the partner website 5A, based on the setting of the creditgood flag, determines whether the user has sufficient earned credits. If yes, in step 43 the partner website 5A displays premium web pages of the partner website 5A containing, for example, premium content, that the user can access and download. The user's account information corresponding to the user's base identifier code, which for example includes the user's home address, email address and other like information, provides that electronic content selected for access can be readily delivered electronically to the user terminal 2 without the user's having to provide such electronic address information when selecting the content on the premium partner website 5A for retrieval. If the user does not have sufficient credits, in step 42 the partner website 5A displays a statement that the user does not have sufficient earned credits to access the premium web pages and provides a link to the base website 4 with the indication that additional credits can be earned by visiting the base website 4. For example, the link, if clicked on by the user, provides that the step 76 of the process 59 is performed.

In an alternative preferred embodiment, the partner website has entered a business arrangement with a base website wherein the partner website generates a temporary permission code identifier on the user terminal if the determination in step 40 is yes. The temporary identifier code provides the partner website with a mechanism to allow the user to have, in step 43, unlimited rights to access content on the partner website for a predetermined time interval, such that the partner website does not have to monitor use of its website by the user. As a result, the partner website does not need to repeatedly perform the transaction subroutine of step 38 each time that the user desires to access premium webpages or premium content on the partner website.

In a further preferred embodiment, the base website generates a universal temporary permission code identifier on the user terminal before step 38 is performed, or after a user performs a search on the base website. The universal temporary identifier provides the user with time limited, unlimited access right's to content on one or more partner websites, regardless if the user has any user credits. In this embodiment, a user can access content on a partner website for free, for a limited period of time, which permits the content partner website to promote its content library to the user. In alternative embodiment, the universal temporary identifier provides the user with time limited and limited access, such as providing a user with access to one webpage per week.

In an alternative preferred embodiment, the user terminal includes a monitoring application, such as a toolbar application, that the base website or partner website downloads to the user terminal after initial registration and prior to the creation of a joint identifier code. The monitoring application operates in the background on the user terminal to monitor a user's activities in connection with a base website and a partner website, such as the user's performing a search on the base website or accessing premium content on a partner website. The monitoring application automatically, or based on upon receipt of a request from the base website, transmits to the base website reports detailing the user's activities in connection with the base website and partner websites.

In a further alternative embodiment, the monitoring application is installed on a user terminal during manufacture of the terminal. The installed monitoring application is programmed to monitor user activities relating to one or more base websites and also their respective partner websites. In addition, a base website can remotely update the monitoring application to add or delete partner websites to be monitored.

Although preferred embodiments of the present invention have been described and illustrated, it will be apparent to those skilled in the art that various modifications may be made without departing from the principles of the invention.

What is claimed is:

1. A method for rewarding use of a communications network site comprising:
providing a base communications network site partnered with at least one partner communications network site, wherein each of the base site and the partner site is coupled to or on a communications network;
registering a user with the base site;
automatically awarding the registered user with a credit based on the registered user's interacting with the base site, wherein the awarding is performed after determining if a user interacting with the base site is registered and logged in with the base site; and
redeeming, at the partner site, at least a portion of the credit awarded to the registered user in exchange for at least one of the following: access to a premium data page available at the partner site, download of premium data available at the partner site, and credit towards at least a portion of a purchase price of a product or service available on the partner site and selected for purchase by the registered user.

2. The method of claim 1, wherein the application includes at least one of the following: an advertisement link, a toolbar and a search engine.

3. The method of claim 1 further comprising inviting a user not registered with the base site to become a registered user when the non-registered user accesses the base site or the partner website.

4. The method of claim 1 further comprising automatically maintaining an accounting of the credits awarded to, used by and available for redemption by the registered user.

5. The method of claim 4, wherein the maintaining of the accounting is performed on at least one of the base website, the partner website and a user communications terminal used by the user.

6. The method of claim 1 further comprising:
determining, when a user accesses the partner website during a communications network session using a user communications terminal, whether the user terminal includes a joint identifier code;
determining if the user terminal includes a base identifier code if the joint identifier code was not found at the user terminal;
providing for user login with the base site if the user terminal includes the base identifier code; and
inviting the user to register with the base website if the user terminal does not include the base identifier code and the user is not registered with the base website, wherein the user automatically is logged in with the base website following registration.

7. The method of claim 6 further comprising:
following login by the registered user with the base site, generating at at least one of the partner site and the base website a joint identifier code for the registered user and placing the joint identifier code on the user terminal.

8. The method of claim 4 further comprising:
determining whether the registered user has sufficient credits to perform an exchange with the partner website; and
permitting the registered user to perform the exchange if sufficient credits are available.

9. The method of claim 1, wherein the base site and the partner website constitute an Internet website.

10. The method of claim 1, wherein the base site and the partner site have common ownership interest.

11. A system for rewarding use of a communications network site comprising:
a base communications network site partnered with at least one partner communications network site, wherein each of the base site and the partner site is coupled to or on a communications network;
wherein the base site automatically awards a user registered with the base site with a credit based on the registered user interacting with the base site, wherein the base site awards the credit if a user interacting the base site is registered and logged in with the base site; and
wherein the partner site redeems at least a portion of the credit awarded to the registered user in exchange for at least one of the following: access to a premium data page available at the partner site, download of premium data available at the partner site, and credit towards at least a portion of a purchase price of a product or service available on the partner site and selected for purchase by the registered user.

12. The system of claim 11, wherein the application includes at least one of the following: an interactive icon, a toolbar and a search engine.

13. The system of claim 11, wherein the partner site or base site invites a user not registered with the base site to become a registered user when the non-registered user accesses the base site or the partner website.

14. The system of claim 11, wherein at least one of the base website, partner website and a user terminal used by the registered user automatically maintains an accounting of the credits awarded to, used by and available for redemption by the registered user.

15. The system of claim 11, wherein when a user accesses the partner website during a communications network session using a user communications terminal, the partner website determines whether the user terminal includes a joint identifier code;
wherein the partner site determines if the user terminal includes a base identifier code if the joint identifier code was not found at the user terminal,
wherein the partner site provides for user log in with the base site if the user terminal includes the base identifier code;
wherein the partner site invites the user to register with the base website if the user terminal does not include the base identifier code and the user is not registered with the base website; and
wherein the base website automatically logs in the user following registration.

16. The system of claim 15, wherein, following login by the registered user with the base site, at least one of the partner site and the base website generate a joint identifier code for the registered user and place the joint identifier code on the user terminal.

17. The system of claim 14, wherein at least one of the base site, the partner site and the user terminal determines whether the registered user has sufficient credits to redeem in an exchange with the partner website; and
wherein the registered user is permitted to perform the exchange if sufficient credits are available.

18. The system of claim 11, wherein the base site and the partner website constitute an Internet website.

19. The system of claim 11, wherein the base site and the partner site have common ownership interest.
